(19) United States
(12) Patent Application Publication
(10) Pub. No.: US 2012/0282381 A1
(43) Pub. Date: Nov. 8, 2012

(54) FLOUR IMPROVER

(75) Inventors: Christian Kroning, Freurilsbert (DE); Rainer Schnee, Mainz (DE); Gideon Rath, Darmstadt (DE)

(73) Assignee: Chemische Fabrik Budenheim KG, Budenheim (DE)

(21) Appl. No.: 13/463,145

(22) Filed: May 3, 2012

(30) Foreign Application Priority Data
May 4, 2011 (DE) 102011075239.0

(51) Int. Cl. A21D 2/04

(52) U.S. Cl. 426/331; 426/622; 426/549

(57) ABSTRACT

A flour improver for the production of doughs loosened by fermentation or physically loosened doughs for bakery products or for the production of flour, wherein the flour improver contains acid magnesium pyrophosphate (magnesium dihydrogen diphosphate) and at least magnesium orthophosphate and has a loss on ignition of between 7.5 and 13.5%, preferably between 9 and 11.5%.

### CROSS REFERENCE TO RELATED APPLICATIONS

This claims priority from German Patent Application 10 2011 075 239.0 filed May 4, 2011.

### BACKGROUND OF THE INVENTION

The invention concerns a flour improver for the production of doughs loosened by fermentation or physically loosened doughs for bakery products, and for the production of flour for such doughs as well as its use and composition, which contain the flour improver.

The baking properties of cereal flours, in particular wheat flours, vary very greatly. Factors which influence the baking properties of flours are for example the climate and the nature of the ground, under which the cereal is grown, and the respective kind The baker working in a manual process can compensate for fluctuations in the properties of the flour to a certain extent by way of ingredients and baking management. In industrial production of bakery products however the baking properties of the raw materials must be substantially constant so that the process can take place uniformly.

Gluten or gluten protein identify a generic term for cereal proteins. They consist of two fractions of which one is alcohol-soluble. Any kind of cereal has slightly different glutens, the alcohol-soluble gluten fractions of which are generally referred to differently, for example gliadin (=wheat gluten), secalin (=rye gluten) and hordein (=barley gluten). The gluten component of a flour is a crucial factor for the baking properties of a cereal flour. In this context bakers refer to low-gluten flour with a low proportion of gluten or high-gluten flour with a high proportion of gluten. In dough preparation the glutens absorb water, that is to say they swell. In that case the protein binds to form a tough stretchable material, the gluten. The proportion of gluten influences for example water binding in the dough, crumb formation, crust formation, the elasticity of the dough such as stretchability and stretch resistance, kneading tolerance, fermentation stability, the bakery product volume and the shelf life of bakery products. Those parameters are particularly important for the production of bread and rolls.

Various additives are used for adjusting the baking properties of cereal flours. In the case of low-gluten flours the addition of oxidising substances such as bromate or the reducing ascorbic acid which in dough preparation is converted to the oxidising dehydroascorbic acid leads to gluten strengthening. However the number of available oxidising agents is limited. Ascorbic acid requires particularly intensive kneading of the dough to get sufficient atmospheric oxygen into the dough, which is required for the oxidation reaction. The addition of bromate has already long been prohibited at least in Germany. Enzymatically active additives such as the lipoxigenase from soya flour lead to an improvement in gluten strength.

Particularly in the case of pastries with a high proportion of flour the gluten strengthening most likely causes the improvement in the baking properties. Bakery products in which starch agglutination plays a decisive roll profit less from that mechanism. Therefore these flour improvers are of significance precisely for fermented and physically loosened doughs. In the case of chemically risen doughs a gluten structure throughout is not wanted, it would rather interfere with gas and volume development in the baking phase. For that reason a greater proportion of starch is used or low-gluten flour is employed in chemically raised doughs.

### BRIEF SUMMARY OF THE INVENTION

The object of the present invention is to provide a flour improver which fortifies the gluten, which can be well worked and which produces short, well-workable doughs.

The invention includes a flour improver for the production of doughs loosened by fermentation or physically loosened doughs for bakery products or for the production of flour, wherein the flour improver contains acid magnesium pyrophosphate (magnesium dihydrogen diphosphate) and at least magnesium orthophosphate and has a loss on ignition of between 7.5 and 13.5%, preferably between 9 and 11.5%.

More particularly, the flour improver preferably contains between 30 and 99% by wt of pyrophosphate expressed as P₂O₅ and between 1 and 70% by wt of orthophosphate expressed as P₂O₅, preferably between 90 and 99% by wt of pyrophosphate expressed as P₂O₅ and between 1 and 10% by wt of orthophosphate expressed as P₂O₅, wherein the percentages by weight refer to the total P₂O₅ content in the flour improver.

The invention also includes a composition containing the flour improver where the composition includes cereal flour and an amount related to the weight of the cereal flour of between 5 ppm by weight and 3% by wt, preferably between 20 ppm by weight and 0.5% by wt, particularly preferably between 50 ppm by weight and 0.1% by wt of a flour improver which contains acid magnesium pyrophosphate (magnesium dihydrogen diphosphate) and at least magnesium orthophosphate and has a loss on ignition of between 7.5 and 13.5%, preferably between 9 and 11.5%.

The invention also includes a method for the production of doughs loosened by fermentation or physically loosened doughs for bakery products or for the production of flour, by inclusion of a flour improver wherein the flour improver contains acid magnesium pyrophosphate (magnesium dihydrogen diphosphate) and at least magnesium orthophosphate and has a loss on ignition of between 7.5 and 13.5%, preferably between 9 and 11.5% and includes a process for the production of a dough for a bakery product, wherein a composition as above described is produced by firstly mixing the flour improver, and possibly further dough constituents, with a part or the whole amount of the flour required for the dough as dry substances and then mixing the dry dough constituents with water.

### DETAILED DESCRIPTION OF THE INVENTION

The object is attained by the use of a flour improver for the production of doughs loosened by fermentation or physically loosened doughs for bakery products or for the production of flour, wherein the flour improver contains acid magnesium pyrophosphate (magnesium dihydrogen diphosphate) and at least magnesium orthophosphate and has a loss on ignition of between 7.5 and 13.5%, preferably between 9 and 11.5%.

The flour improver according to the invention can be added to all bakable flours, for example wheat, rye and spelt flours. In comparison with ascorbic acid as the most frequently used flour improver the flour improver used according to the invention has the advantage that it can be better incorporated into the dough and gives surprisingly comparable or better baking results. In addition it supplies the body with magnesium upon consumption of the bakery products produced therewith and can thus represent an advantageous nutritional supplement.

The flour improver according to the invention leads to an improvement in the baking properties, in particular it affords an increased stretch resistance, higher kneading tolerance and fermentation stability for the dough. Pastry volume and crumb structure are also improved. The crumbs become softer and have a fresher effect. The stickiness of the doughs decreases. Stability in relation to frost damage and loss of baking capability in the onset of an interruption in fermentation or in the event of deep freezing of green (fresh) or precooked bread is enhanced by the flour improver according to the invention.

The flour improver according to the invention can be added solely to the main constituents of a dough like flour, water, salt and yeast or in combination with other baking agents or flour improvers such as for example ascorbic acid, emulsifiers, enzymes and so forth. It can also be a constituent part of a baking agent, a premix or a baking mixture. The term baking agents is used to denote additives which permit or simplify the production of bakery products and compensate for the varying process properties of the raw materials. The term baking agents also embraces a mixture of a plurality of or all required additives. A premix is a preliminary mixture to which the flour is also added for production of the dough.

The flour improver used according to the invention is not a pure substance but a mixture of substances which due to the manner of manufacture thereof contains at least acid magnesium pyrophosphate and magnesium orthophosphate. When reference is made herein to proportions or percentage by weight (% by wt) of pyrophosphate P₂O₅ or orthophosphate P₂O₅ then that refers in each case to the proportion of P₂O₅ present in the form of pyrophosphate or orthophosphate, relative to the total P₂O₅ content in the product, in which respect it is clear to the man skilled in the art that the reference to ‘P₂O₅’ is here as the calculated reference value which is usual in the art for specifying the phosphate content.

The loss on ignition of the flour improver according to the invention is in the range of between 7.5 and 13.5%. In a preferred embodiment of the invention the flour improver according to the invention has a loss on ignition of between 9 and 11.5%. An excessively low loss on ignition has the disadvantage that a proportion of long-chain magnesium phosphates occurs. An excessively high loss on ignition has the disadvantage that the product has a tendency to form lumps upon storage. The loss on ignition is determined by strongly heating about 2 g of sample at 800° C. for 30 min and determining the loss of mass in the heating operation.

In accordance with the present application the term ‘dough’ embraces both doughs and also masses as are understood by the man skilled in the art.

In accordance with the present invention doughs loosened by fermentation embrace those doughs in which loosening and pore formation is effected by means of micro-organisms which produce and give off gas, generally carbon dioxide, in the dough due to fermentation, to loosen the dough. Such micro-organisms include in particular yeasts and lactic acid bacteria. In accordance with the present invention doughs loosened by fermentation are in particular yeast doughs and sour doughs.

In accordance with the present invention physically loosened doughs embrace those doughs in which loosening and pore formation is effected physically by impacting with air—with or without pressure—or in which loosening and pore formation is effected with water vapor. Examples of doughs loosened with water vapor are puff pastries and choux pastries. In the case of puff pastries the many dough-fat layers produced by lamination form a water vapor barrier and the water vapor produced in the baking heat then leads to the typical flaky structure of the bakery product.

In accordance with the present application chemically raised doughs are those in which loosening and pore formation is effected by chemical reaction of acids or acid salts with a carbon dioxide carrier like sodium hydrogen carbonate. Chemically raised doughs in accordance with the present application are not doughs which have been loosened by fermentation and not physically loosened doughs.

In an embodiment of the invention the flour improver can be produced by thermally removing water from an aqueous solution or suspension of a magnesium phosphate compound having a molar ratio of Mg:P of 0.4-0.6:1. Preferably according to the invention monomagnesium orthophosphate is used for that purpose. It has a theoretical molar ratio of Mg:P of 0.5:1.0. The aqueous solution or suspension of the magnesium phosphate compound, from which the flour improver according to the invention can be obtained by the removal of water, does not have to be produced by dissolving or suspending a magnesium orthophosphate. It can also be produced by stirring a magnesium compound into phosphoric acid.

Preferably the water removal operation is effected at between 140 and 300° C., preferably at between 180 and 250° C. An excessively low water removal temperature has the disadvantage of incomplete or a low level of pyrophosphate formation. An excessively high water removal temperature has the disadvantage that unwanted long-chain magnesium phosphates are formed.

The flour improver according to the invention can advantageously be produced by the removal of water in a rotary kiln or in a spray tower. Upon production in a rotary kiln it is possible to use both the co-flow and also the counter-flow process. In the co-flow process the phosphate solution is sprayed through a flame extending into the rotary kiln on to a hot bed of product from which water has already been removed. The material then moves with the hot air flow to the discharge end and in so doing water is removed therefrom. In production in a spray tower the phosphate solution is sprayed into the spray tower head by way of multi-substance nozzles. A flame zone is generated by burners in the spray tower head. The sprayed-in phosphate solution moves in co-flow relationship with the burner gases downwardly and in so doing water is removed therefrom.

In a further embodiment of the invention the flour improver contains between 30 and 99% by wt of pyrophosphate P₂O₅ and between 1 and 70% by wt of orthophosphate P₂O₅, wherein the percentages by weight refer to the total P₂O₅ content in the flour improver. Between 90 and 99% by wt of pyrophosphate P₂O₅ and between 1 and 10% by wt of orthophosphate P₂O₅ are particularly suitable.

The invention also embraces a composition which contains cereal flour and an amount related to the weight of the cereal flour of between 5 ppm by weight and 3% by wt, preferably between 20 ppm by weight and 0.5% by wt, particularly preferably between 50 ppm by weight and 0.1% by wt of the flour improver described herein which contains acid magnesium pyrophosphate (magnesium dihydrogen diphosphate) and at least magnesium orthophosphate and has a loss on ignition of between 7.5 and 13.5%, preferably between 9 and 11.5%.

In a particularly preferred embodiment of the invention the composition according to the invention which contains the flour improver according to the invention is a flour for the production of bakery products, quite particularly preferably a wheat flour. When the composition is referred to herein as a flour, this means a composition which as the main constituent contains flour (more than 85% by weight) and the flour improver according to the invention as well as optionally further flour additives added in small amounts.

In a further preferred embodiment of the invention the composition according to the invention, containing the flour improver according to the invention, is a baking mixture for the production of bakery products. In this context the term baking mixture is used to denote a composition which in an already premixed condition contains all essential dry constituents for the production of a dough. For dough preparation essentially only water is added to the baking mixture, in which respect the further addition of additives or flavors and so forth is not excluded.

In a further preferred embodiment of the invention the composition according to the invention, containing the flour improver according to the invention, is a dough loosened by fermentation or a physically loosened dough for bakery products. It has surprisingly been found that the addition of the flour improver according to the invention, in the case of doughs loosened by fermentation and physically loosened doughs, has a particularly advantageous effect on dough production, dough processing and the properties of the bakery products produced therefrom. The addition of the flour improver according to the invention affords for example excellent stretchability and good stretching resistance for the dough and improved crumb for the bakery product produced. In comparison with the use of ascorbic acid as the flour improver, it was possible with the flour improver according to the invention to achieve a lower level of susceptibility to the dough tearing away from the crust of the cakes and pastries, that is to say a higher level of fermentation tolerance.

The invention further embraces a process for the production of a dough for a bakery product, using the flour improver according to the invention, in which a composition of the above-described kind according to the invention is produced by firstly the flour improver and possibly further dough constituents being mixed with a part or the whole amount of the flour required for the dough as dry substances and then mixing the dry dough constituents with water. Incorporation of the flour improver according to the invention into an already moist dough has proven to be disadvantageous as sufficiently homogeneous distribution of the flour improver in the dough cannot be achieved or can be achieved only by very long and intensive kneading, which in turn entails disadvantages in regard to the nature of the dough and increases the costs and duration of dough production.

The use of a flour improver for the production of doughs loosened by fermentation or physically loosened doughs for bakery products or for the production of flour, which contains neutral magnesium pyrophosphate (dimagnesium diphosphate), magnesium orthophosphate or a mixture thereof is also claimed. That flour improver can be used in the same concentrations of use as the flour improver according to the invention with acid magnesium pyrophosphate in a composition which contains cereal flour and an amount of the flour improver, that is related to the weight of the cereal flour.

The invention will now be further described by means of Examples which do not limit the scope of protection of the invention.

### Example 1

### Dough Rheology

To measure dough rheology four dough batches each comprising 300 g of flour of type 550, 6 g of salt and water were produced in accordance with ICC Standard No 114/1 and processed as specified. Additives in accordance with Table 1 hereinafter were incorporated into the four dough batches. The amounts of water used were so adjusted that the dough batches were of an identical consistency of 500 BU. Dough strands each of 150 g were produced from each dough batch and left at rest for 45 min or 135 min at 300° C. Extensograms were then recorded with a Brabender extensograph in a triple determination mode.

TABLE 1
Dough batches for determining dough rheology

| | | | Amount of water |
|---|---|---|---|
| Dough batch | Additive | Amount | (g/300 g of flour) |
| A1 (comparison) | — | — | 183.9 |
| B1 (comparison) | ascorbic acid | 20 ppm | 179.7 |
| C1 (invention) | MgPP | 60 ppm | 177.9 |
| D1 (invention) | MgPP | 1% by wt | 177.6 |

MgPP=flour improver according to the invention with magnesium pyrophosphate and magnesium orthophosphate with 95.8% by wt of pyrophosphate P₂O₅ and 4.2% by weight of orthophosphate P₂O₅.

The results of determining the stretch resistance and stretchability are set forth in Tables 2 and 3 hereinafter.

TABLE 2
Determining the stretch resistance and stretchability
of the dough preparation after 45 min

| | Stretch | Stretch- | Stretch | Stretch- |
|---|---|---|---|---|
| | resistance | ability in | resistance | ability (% |
| | in BU | mm | (% in rela- | in relation |
| Dough batch | (45 min) | (45 min) | tion to A) | to A) |
| A1 (comparison) | 250 | 188 | 100 | 100 |
| B1 (comparison) | 330 | 178 | 132 | 95 |
| C1 (invention) | 330 | 174 | 132 | 93 |
| D1 (invention) | 230 | 172 | 92 | 91 |

TABLE 3
Determining the stretch resistance and stretchability
of the dough preparation after 135 min

| | Stretch | Stretch- | Stretch | Stretch- |
|---|---|---|---|---|
| | resistance | ability in | resistance | ability (% |
| | in BU | mm | (% in rela- | in relation |
| Dough batch | (135 min) | (135 min) | tion to A) | to A) |
| A1 (comparison) | 410 | 155 | 100 | 100 |
| B1 (comparison) | 510 | 148 | 124 | 95 |
| C1 (invention) | 520 | 155 | 127 | 100 |
| D1 (invention) | 520 | 140 | 127 | 90 |

‘BU’ = Brabender units

With an addition of 60 ppm of the flour improver according to the invention (dough C1) the stretch resistance increases in relation to a dough without addition (dough A1) by over 30% and the stretchability has a tendency to be lower. The dough strengthening is comparable to the addition of 20 ppm of ascorbic acid (dough B1). A high dosage of 1% of the flour improver according to the invention (dough D1) admittedly led to a reduction in the stretch resistance in the early phase of dough preparation (45 min), but in the further procedure (135 min) that high dosage also had a dough-strengthening effect.

### Example 2

### Production of White Bread

The basic dough used in this Example was of the following composition:

| | Amount | |
|---|---|---|
| | [gram] | Parts by wt |
| Wheat flour | 1841 | 100 |
| (type 550 in accordance with DIN 10355) | | |
| Water | 1128 | 60 |
| Yeast | 56 | 3 |
| Salt | 37 | 2 |

Four different dough batches were produced and additives in accordance with Table 4 hereinafter were incorporated. The additives were intensively mixed into the dry flour prior to the addition of the water and the other dough constituents to achieve uniform distribution. Fermentation of the doughs was effected at 35° C. and 80% relative air humidity.

TABLE 4
Dough batches for the production of white bread

| Dough batch | Additive | Amount |
|---|---|---|
| A2 (comparison) | — | — |
| B2 (comparison) | Ascorbic acid | 20 ppm |
| C2 (invention) | MgPP | 60 ppm |
| D2 (invention) | MgPP | 1% by wt |

MgPP=flour improver according to the invention with magnesium pyrophosphate and magnesium orthophosphate with 95.8% by wt of pyrophosphate P₂O₅ and 4.2% by wt of orthophosphate P₂O₅.

Using the doughs, open white tin loaf was baked both after normal fermentation (NF: 35° C., 80% relative air humidity, 85 min) and also after over-fermentation (OF: 35° C., 80% relative air humidity, 100 min) of the doughs and crumb nature was assessed. The results are reproduced in Table 5 hereinafter.

TABLE 5
Assessment of the crumb nature of white
tin loaf from doughs A2 through D2

| | Crumb nature | |
|---|---|---|
| Dough | Normal fermentation (NF) | Over-fermentation (OF) |
| A2 (comparison) | 4 pastry-typical | 5 rather soft |
| B2 (comparison) | 4 pastry-typical | 5 rather soft |
| C2 (invention) | 5 rather soft | 6 soft |
| D2 (invention) | 5 rather soft | 6 soft |

Assessment of the crumb nature was effected on a scale of 1 through 6, wherein the value 4 corresponds to a pastry-typical crumb nature.

The crumb nature of the white tin loaves baked with the flour improver according to the invention (doughs C2 and D2) was softer than in the case of loaves without additive (dough A2) or with ascorbic acid (dough B2). As a result they had a fresher effect. In addition, particularly in the case of the white tin loaves baked with over-fermented dough, it was clearly apparent that the loaves with the addition of flour improver according to the invention (doughs C2 and D2), upon baking, had a lesser tendency to the crust tearing away and thus have a better fermentation tolerance than the loaves without additive (dough A2) or with ascorbic acid (dough B2).

### Example 3

### Production of Round Pieces with Fermentation Interruption

The basic dough used in this Example was of the following composition:

| | Amount | |
|---|---|---|
| | [gram] | Parts by wt |
| Wheat flour | 4000 | 100 |
| (type 550 in accordance with DIN | | |
| 10355) with 10 ppm of ascorbic acid | | |
| Salt | 80 | 2 |
| Sugar | 40 | 1 |
| Yeast | 200 | 5 |
| Water | 2400 | 60 |

Two different dough batches were produced, namely the above-mentioned basic dough without further additives and the basic dough with an addition of 0.5% by wt of MgPP (=flour improver according to the invention with magnesium pyrophosphate and magnesium orthophosphate with 95.8% by wt of pyrophosphate P₂O₅ and 4.2% by wt of orthophosphate P₂O₅).

Ten round pieces were respectively produced from each of the dough batches. The loaves of bread were cooled for 1 h at −20° C. and then kept at −18° C. over 7 h, thawed at +8° C. for 4 h and thereafter left to ferment for 2 h at 28° C. and 70% relative air humidity. The round pieces were then baked in the baking oven for 2 min at 240° C. and for a further 18 min at 220° C., the last 5 min with an open draft, and the specific volume of the round pieces baked from the various dough batches was determined. The specific volume of the round pieces from the basic dough without MgPP was 4.76 ml/g and the specific volume of the round pieces from the basic dough with 0.5% by wt of MgPP was 5.08 ml/g and was thus 6% higher than without MgPP.

What is claimed is:

1. A method for the production of doughs loosened by fermentation or physically loosened doughs for bakery products or for the production of flour by inclusion of a flour improver, wherein the flour improver comprises acid magnesium pyrophosphate (magnesium dihydrogen diphosphate) and at least magnesium orthophosphate and has a loss on ignition of between 7.5 and 13.5%.

2. The method of claim 1 wherein the loss on ignition is between 9 and 11.5%.

3. The method of claim 1 wherein the flour improver comprises between 30 and 99% by wt of pyrophosphate expressed as P₂O₅ and between 1 and 70% by wt of orthophosphate expressed as P₂O₅, wherein the percentages by weight refer to the total P₂O₅ content in the flour improver.

4. The method of claim 1 wherein the flour improver comprises between 90 and 99% by wt of pyrophosphate expressed as P₂O₅ and between 1 and 10% by wt of orthophosphate expressed as P₂O₅, wherein the percentages by weight refer to the total P₂O₅ content in the flour improver.

5. The method of claim 1 wherein the flour improver is produced by removing water from an aqueous solution or suspension of a magnesium phosphate compound which has a molar ratio of Mg:P of 0.4-0.6:1.

6. The method of claim 5 wherein water is removed at between 180 and 250° C.

7. The method of claim 5 where the water is removed at between 140 and 300° C.

8. A composition which contains cereal flour and an amount related to the weight of the cereal flour of between 5 ppm by weight and 3% by wt. of a flour improver which contains acid magnesium pyrophosphate (magnesium dihydrogen diphosphate) and at least magnesium orthophosphate and has a loss on ignition of between 7.5 and 13.5%,

9. The composition of claim 8 wherein the flour improver is between 50 ppm by weight and 0.1% by wt. and the loss on ignition of the flour improver is between 9 and 11.5%.

10. The composition of claim 8 wherein the flour improver is between 20 ppm by weight and 0.5% by wt. and the loss on ignition of the flour improver is between 9 and 11.5%.

11. The composition of claim 8 wherein the flour improver is produced by removing water from an aqueous solution or suspension of a magnesium phosphate compound which has a molar ratio of Mg:P of 0.4-0.6:1 by removing water at between 140 and 300° C.

12. A composition as set forth in claim 8 wherein the flour improver contains between 30 and 99% by wt of pyrophosphate expressed as P₂O₅ and between 1 and 70% by wt of orthophosphate expressed as P₂O₅, wherein the percentages by weight refer to the total P₂O₅ content in the flour improver.

13. A composition as set forth in claim 8 wherein the flour improver contains between 90 and 99% by wt of pyrophosphate expressed as P₂O₅ and between 1 and 10% by wt of orthophosphate expressed as P₂O₅, wherein the percentages by weight refer to the total P₂O₅ content in the flour improver.

14. A composition as set forth in claim 8 wherein the composition is a dough loosened by fermentation or a physically loosened dough for bakery products, a flour for the production of bakery products or a baking mixture for the production of bakery products.

15. The method of claim 1 wherein a composition, which contains cereal flour and an amount related to the weight of the cereal flour of between 5 ppm by weight and 3% by wt. of a flour improver which contains acid magnesium pyrophosphate (magnesium dihydrogen diphosphate) and at least magnesium orthophosphate and has a loss on ignition of between 7.5 and 13.5%, is produced by firstly the flour improver and possibly further dough constituents being mixed with a part or the whole amount of the flour required for the dough as dry substances to obtain a dry dough and then mixing the dry dough with water to obtain a dough.

16. The method of claim 13 wherein the flour improver contains neutral magnesium pyrophosphate (dimagnesium diphosphate), magnesium orthophosphate or a mixture thereof.
